(19) United States
(12) Patent Application Publication
(10) Pub. No.: US 2011/0304473 A1
(43) Pub. Date: Dec. 15, 2011

(54) Residential emergency activated locating device (RLD)

(76) Inventors: J. Antonio Ayala, Southport, NC (US); John Frederick Hall, Southport, NC (US)

(21) Appl. No.: 12/802,718

(22) Filed: Jun. 14, 2010

(51) Int. Cl. G08B 5/00

(52) U.S. Cl. 340/691.8

(57) ABSTRACT

An emergency location apparatus is described including a power source, a control panel for one of activating and de-activating a high intensity light and an activation switch. Also described is a method for operating an emergency location apparatus including receiving a signal, determining if the received signal is an activation signal and one of activating a high intensity light and de-activating said high intensity light.

### FIELD OF THE INVENTION

The present invention relates to an emergency device and, in particular, to a device for improving emergency response time in locating an address in residential, multiple family housing, and/or small business areas when situations arise that threaten personal property, home security, personal safety or health.

### BACKGROUND OF THE INVENTION

Emergency response time to residential homes, multiple family housing, and/or small business areas for medical, fire, security and other safety concerns is currently contingent on locating address numbers and letters placed on or near the location in an increasing number of random locations (porches, mailboxes, decorative stakes in landscaping, etc.) leaving no standard method to determine quickly which location is in need of the emergency assistance.

This proves to make things even more difficult for emergency responders at night when numbers and letters, even when displayed properly, still may not be visible costing valuable time in an emergency. In extreme cases, when time is of the essence but a response team's visibility is hampered they spend valuable time calling for additional assistance and/or driving around trying to pinpoint the exact location in need of help.

A highly visible signaling device that can alert emergency responders in a timely manner would be most advantageous not only to the responders, but those in need of emergency assistance, ultimately benefiting the homeowners, neighbors, businesses, insurance companies and the community at large. The primary purpose of the signaling device would be to save precious time when responding to life threatening medical, security and personal property emergencies.

### SUMMARY OF THE INVENTION

The present invention is a highly visible pulsating light which is located in an agreed upon standard place outside the building or residence, possible in more than one location, to be determined by safety and code enforcement officials when a building permit is issued.

This signaling light would operate at any time and guide, especially at night, the first response team much more quickly and without question to the location at which the emergency was occurring.

The present invention would be installed during construction of a new residence in standard and consistent locations in much the same way as smoke detectors are installed in standard locations. Approved locations to be verified during certificate of occupancy inspection process in compliance with local codes and regulations. It could also be installed in existing building or dwellings much the same way as new construction as long as it is in a highly visible location(s) which emergency personnel can easily spot from the road for a faster response that will ultimately save lives and property.

The present invention is a bright or high intensity, pulsating (or strobe) light energized by a control panel. This light is installed in a highly visible location(s) and used for alerting responders to an emergency whether occupied or vacant. The signaling light of the present invention may be activated by any of the following ways:
1. Manually, operating a switch strategically placed inside the residence
2. Automatically engaged by a security (e.g., burglar) alarm
3. Automatically energized by fire alarm (smoke, fire or CO detectors)
4. A reply confirmation to a 911 call
5. Any other electronic interface device (e.g. computer driven) or an external telematics device generating a wireless activation signal, such as Life Alert™, OnStar™, EPIRB™, etc. that initiated a wireless GPS (Global Positioning System) address finder confirming back to the signaling device of the present invention. Telematics is the transmission of data over a communication network between safety, security systems and devices by means of wireless GPS signals.

An emergency location apparatus is described including a power source, a control panel for one of energizing and de-energizing a high intensity light and an activation switching device. Also described is the logic for operating an emergency location apparatus including receiving a signal, determining if the received signal is an activation signal and one of activating a high intensity light and de-activating said high intensity light.

### BRIEF DESCRIPTION OF THE DRAWINGS

The present invention is best understood from the following detailed description when read in conjunction with the accompanying drawings. The drawings include the following figures briefly described below:

FIG. 1 is a schematic diagram of an exemplary embodiment of the present invention.

FIG. 2 is a schematic diagram of an alternative exemplary embodiment of the present invention.

FIG. 3 is a flowchart of an exemplary embodiment of the present invention.

FIG. 4 is a flow chart describing the operation of the activation devices.

### DETAILED DESCRIPTION OF THE PREFERRED EMBODIMENTS

The present invention includes a dedicated 110-volt, Electric Power Feeder from the residence distribution box (not shown); a Control Panel, an Activation Device and a High Intensity Light. An optional solar power supply can be incorporated to back-up the main power source in the event of power interruptions.

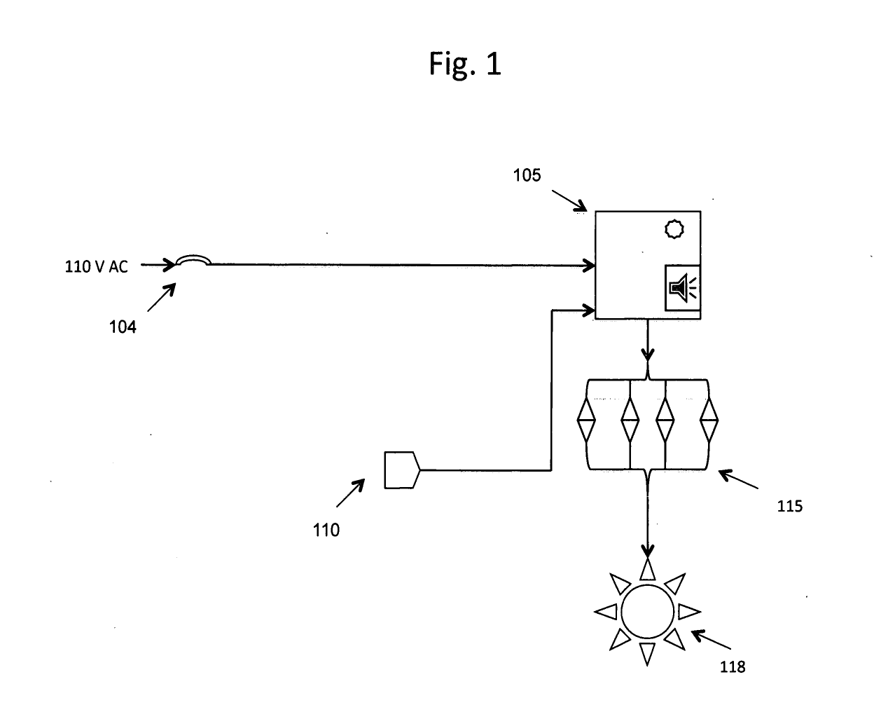

FIG. 1 is a schematic diagram of an exemplary embodiment of the present invention. In this embodiment a 110 Volt AC power feed (104) is connected to the control panel (105), which is also alternatively powered by a solar cell backup in the event of a power failure or interruption (110). The control panel is connected to an activation device (115) which is operated by a user throwing a manual switch, an alarm from a security system (burglar, fire, smoke, CO detector, etc), or any other electronic device as suggested above. The activation device receives an enabling signal from the control panel and turns on the high intensity signaling light.

The 110 volts AC power supply is transformed, converted to a DC signal, rectified and conditioned by the control panel by means known in the art such as by a transformer, an AC/DC converter and a rectifier/wave conditioner. Alternate power source (110) is driven from a solar panel wired to a power sensing and power source selection circuit in the control panel. The power sensing and power source selection circuit chooses between the preferred main source of power or the alternative power source. The alternate power source (110) provides a secondary source of electricity in the event of main power interruptions. This is engaged through a set of dry relay contacts normally open when power is supplied from the primary source and, closed when power is interrupted to connect the alternative solar source.

Either the primary (normal) or the alternative source of power charges a rechargeable 12-volt battery (not shown) for an uninterruptible redundant supply of power to enhance reliability (Uninterruptible Power Supply or UPS-111). The UPS status is continuously monitored and an audible and visible signal on the control panel serves as an alarm to indicate the battery(ies) needs replacement.

The control panel also includes a strobe signal generator circuit that adjusts the light frequency of oscillation and intensity that provides the strobe-like operation.

A high intensity light (118) is a light fixture placed on a strategic external location of the building or residence, easily visible from the road that can alert the emergency response team of the call for help. The color of the light can be changed subject to compliance with local, city and fire codes.

After the emergency has been resolved, operation of the locating device of the present invention can be shut off by a reset or turn-off button on the Control Panel (105)

All wiring from and to the circuit breaker, the solar cell panel and the high intensity light (118) is AWG #14/3, 600 volts, copper conductors for indoor and outdoor installations.

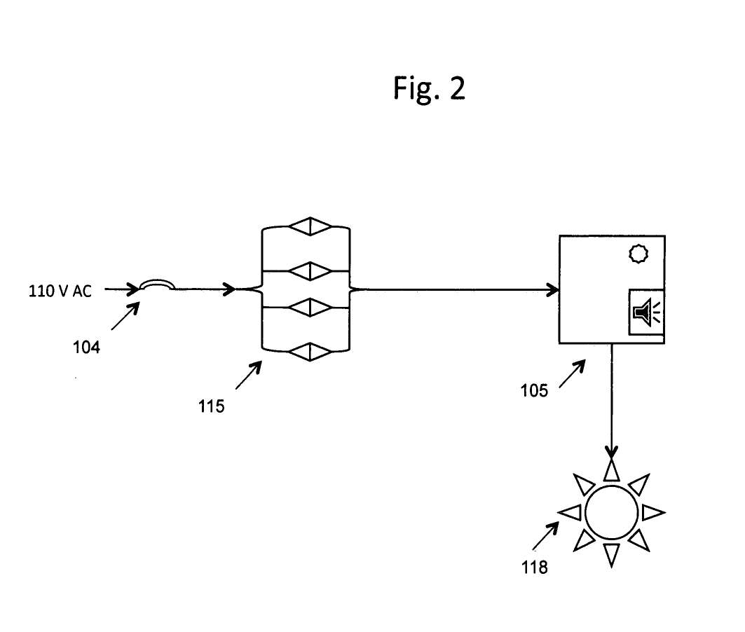

Referring now to FIG. 2, which is an alternative exemplary embodiment of the present invention, at the left is the 110-volt AC power supply (104) from the distribution box (not shown) of the building, moving to the right is the activation device which is activated by a user throwing a manual switch, an alarm from a security system (burglar, fire, smoke, CO detector, etc), any other electronic device as suggested above. The control panel (105) receives an activation signal from the activation device (115) and turns on the high intensity signaling light (118). The dedicated 110-volt, electric power feeder (104) includes a circuit breaker from the electric distribution box (not shown) wired directly to the activation device.

The control panel (105) converts a 110-volt alternating current (AC) signal to a 12-volt direct current (DC) power source that supplies a high intensity light (118) through any one of the alarm lines of the activation device (115) described above. The 110 volts AC power supply is transformed, converted to a DC signal, rectified and conditioned by the control panel by means known in the art such as by a transformer, an AC/DC converter and a rectifier/wave conditioner. The activation device is a passive switching device that only enables the power from reaching the control panel by closing the electric loop.

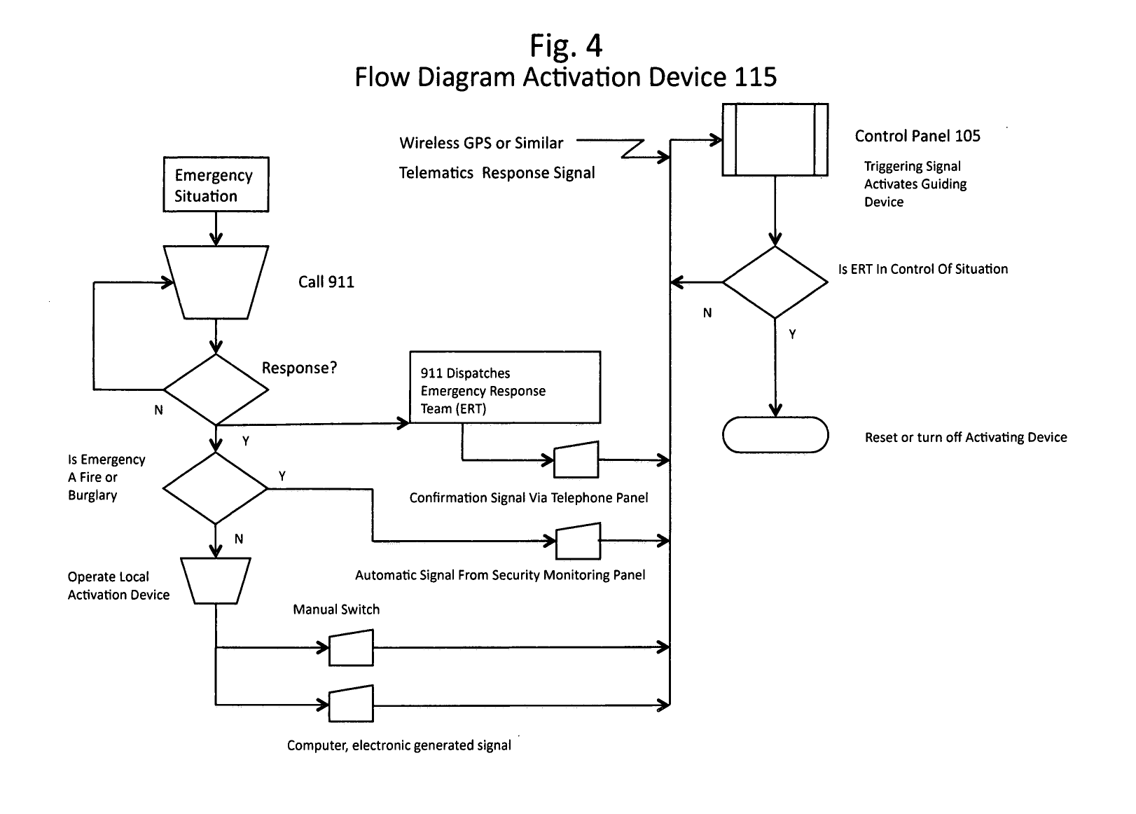

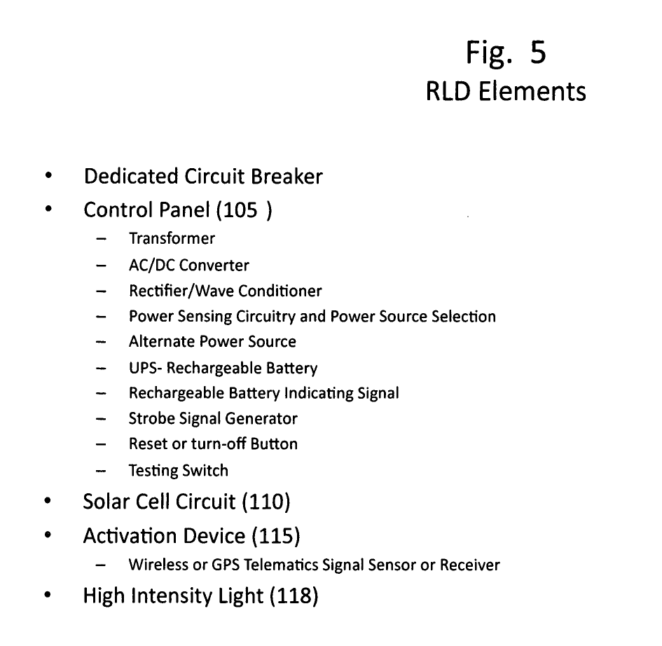

The best way to explain the function of the activation device (115) is to describe each by way of a flowchart (FIG. 4). When an emergency situation arises at a building or residence one of the first actions that takes place is a call to 911 by either a human operator or by a security system. Once a 911 operator responds and he or she determines the severity of the emergency requires the dispatching of a first response team, the 911 operator then has the capability of initiating the operation of the locating device of the present invention by a confirmation telephone signal. The confirmation signal is fed back to the control panel (105) either via a direct wired line connection or a wireless connection.

If the emergency is a fire or burglary break-in an automatic signal will be generated directly from a security monitoring panel. Again this will require a control wiring connection between the security panel and the control panel (105) of the locating device of the present invention. Otherwise, activation of the locating device of the present invention will come from within the building: either by directly tripping a manual switch or by triggering a call-for-help device. The present invention would be activated when a wireless or GPS signal is received from a computer or a telematics device confirming the original call-for-help signal has been sent (wireless or telematics signal sensor or receiver). The present invention may also be triggered from a wireless GPS address finding signal confirming first response team is on its way to respond to an initiated call-for-help request.

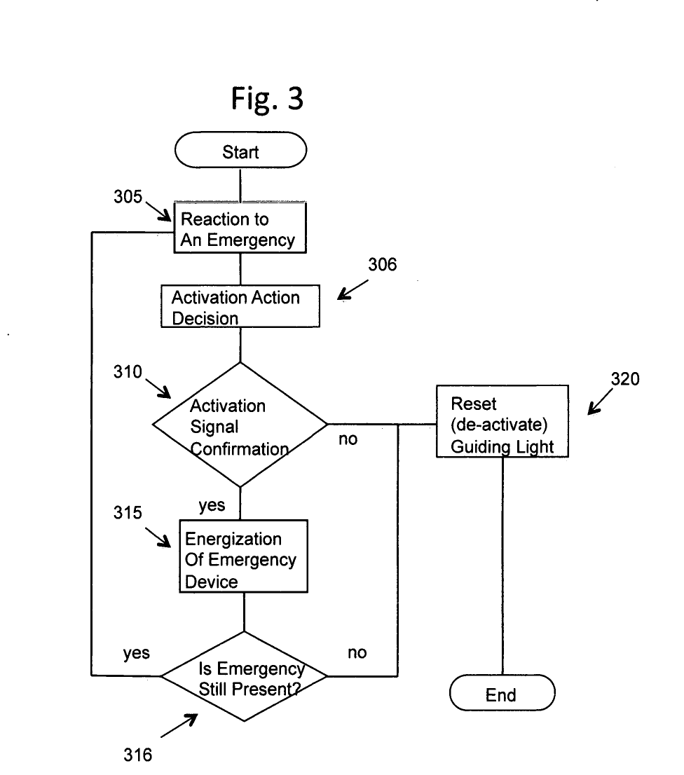

In a more general representation, in the block flow diagram described in FIG. 3, a reaction to an emergency (305) prompts the decision for an activation action (306) with a confirmation feedback signal (310) to trigger the operation of the activation device of the embodiment of the present invention (315). A test is performed at 310 to determine if an activation signal is present. That is, if the signal is a wireless GPS signal or a signal manually triggered at the location of the emergency or a signal automatically initiated by a security system or a telematics response signal or a signal from an emergency response team on the way to the site of the emergency in order to activate the device of the present invention. If the received signal is an activation signal then at 315 the high intensity guiding light of the present invention is energized. If the received signal is not an activation signal then at 320 the received signal must be a rest signal so the high intensity guiding light of the present invention is de-activated.

The elements of the present invention (FIG. 5) include a dedicated circuit breaker (104), a control panel (105), optionally a solar cell circuit (110), an activation switching device (115) and a high intensity guiding light (118). The control panel includes a transformer, an AC/DC converter, a rectifier/wave conditioner, a power sensing circuitry and power source selection circuitry, optionally a UPS rechargeable battery, optionally a rechargeable battery low indicator signal, a strobe signal generator (for generating a signal to the high intensity guiding light, which may be a strobe light), a reset or de-activation button, and a testing switch. The control panel may be implemented in any other manner with more or less elements than those listed above in any manner known in the art. The activation device includes a wireless or GPS telematics signal sensor or receiver.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. An emergency location apparatus, comprising:
a power source;
a control panel for one of activating and de-activating a high intensity light; and
an activation switch.

2. The apparatus according to claim 1, wherein said power source is 110 volts of AC power.

3. The apparatus according to claim 2, wherein said control panel transforms, converts, rectifies and conditions power from said power source.

4. The apparatus according to claim 1, further comprising an optional solar power source.

5. The apparatus according to claim 4, further comprising a 12 volt rechargeable uninterruptable power supply battery and an alarm indicative of low battery.

6. The apparatus according to claim 1, wherein said high intensity light is a strobe light.

7. A method, said method comprising:
receiving a signal;
determining if said received signal is an activation signal; and
one of activating a high intensity light and de-activating said high intensity light.

8. The method according to claim 7, wherein said high intensity light is one of a pulsating light and a strobe light.
